(19) United States
(12) Patent Application Publication
(10) Pub. No.: US 2025/0245523 A1
(43) Pub. Date: Jul. 31, 2025

(54) SYSTEM AND METHOD FOR DOMAIN GENERALIZATION AND APPLICATIONS THEREOF

(71) Applicant: YAHOO ASSETS LLC, New York, NY (US)

(72) Inventors: Ariel Livshits, Petah-Tiqwa (IL); Noa Avigdor-Elgrabli, Haifa (IL); Haggai Toledano, Kiryat Atta (IL); Shadi Iskandar, Haifa (IL)

(21) Appl. No.: 18/427,273

(22) Filed: Jan. 30, 2024

(51) Int. Cl. G06N 5/02

(52) U.S. Cl. CPC G06N 5/02

(57) ABSTRACT

The present teaching relates to attribute extraction from textual content. A domain-invariant attribute extraction model is trained for extracting predetermined attributes from textual content from multiple domains based on training data having a plurality of training samples, each with textual content, some of the predetermined attributes in the textual content, and a label indicating one of the multiple domains that produces the textual content. The domain-invariant attribute extraction model learns via training the semantics of the predetermined attributes across the multiple domains so that when a new textual content from any of the multiple domains, some predetermined attributes are extracted according to semantics thereof via the domain-invariant attribute extraction model.

### BACKGROUND

### 1. Technical Field

The present teaching generally relates to electronic content processing. More specifically, the present teaching relates to extracting information from content.

### 2. Technical Background

With the development of the Internet and the ubiquitous network connections, communications occur mostly via electronic means such as online social media platforms and electronic mail (email) systems. Such communications may be personal, commercial, social, and even political. For example, a user may carry out an online transaction such as ordering a product and receive one or more emails informing the user, e.g., the confirmation of the order and the status of the delivery at different points of time. Given the trend that most activities are nowadays conducted via online platforms, it is frequently the case that many users are faced with a huge amount of information but have limited time to deal with it.

Efforts have been made to extract relevant information from the huge amount of data and provide, e.g., a condensed summary, For example, if a user ordered a product from Etsy and received multiple emails related to the transaction, including an email to confirm the transaction, an email informing the user that the seller is ready to ship the product, an email indicating a warehouse location of the product at each stop, an email reporting the readiness of the shipment of the local postal office, and an email informing the user of the actual delivery to the destination. In this example, depending on the date, information the user desires to know can be limited to certain attributes associated with the transaction, such as the product's name, price, and delivery date. Instead of digging into all the emails sent relating to the transaction, techniques have been developed to extract such relevant information from multiple emails.

An exemplary conventional system is illustrated in FIG. 1. As shown, in this conventional system, there are multiple web-domains 110 (including web-domain 1 110-1, web-domain 2 110-2, . . . , web-domain k 110-k) that produce communications such as emails with textual content. For instance, such web-domains may include Amazon, Etsy, LinkedIn, etc. To extract useful attributes from textual content from different web-domains, the textual content from each domain may be processed by a textual attribute extractor 120 to identify relevant attributes based on an attribute extraction model 130. Conventionally, as desired attributes from different web-domains may be embedded in different ways (e.g., attributes relating to product name, price, and delivery information may be organized differently in an Amazon's email than that in Etsy's email). Given that, the attribute extraction model 130 may be trained, by an attribute extraction model training engine 140 to process textual information from different domains in a way that is appropriate for the given domain. In conventional systems, domain-specific rules 150 may be based on to train the attribute extraction model 130 to extract desired attributes embedded in the textual content from a particular web-domain according to the domain-specific rules.

Such conventional approaches have significant limitations because not all content is structured in a known and fixed manner. FIG. 2 illustrates that online content from different domains may be structured (e.g., email from Amazon on a transaction), semi-structured, and unstructured. While rules may exist to specify how attributes may appear in structured content and some semi-structured content, no rules may be utilized for extracting attributes from unstructured and even some semi-structured content. In addition, developing rules for different domain content requires human labor and can be time consuming and whenever rules change, more human effort is needed, making it inefficient.

Thus, there is a need for a solution that can tackle the issue associated with the conventional approach to extract attributes from textual content from different domains.

### SUMMARY

The teachings disclosed herein relate to methods, systems, and programming for information management. More particularly, the present teaching relates to methods, systems, and programming related to content processing and categorization.

In one example, a method, implemented on a machine having at least one processor, storage, and a communication platform capable of connecting to a network for attribute extraction from textual content. A domain-invariant attribute extraction model is trained for extracting predetermined attributes from textual content from multiple domains based on training data having a plurality of training samples, each with textual content, some of the predetermined attributes in the textual content, and a label indicating one of the multiple domains that produces the textual content. The domain-invariant attribute extraction model learns via training the semantics of the predetermined attributes across the multiple domains so that when a new textual content from any of the multiple domains, some predetermined attributes are extracted according to semantics thereof via the domain-invariant attribute extraction model.

In a different example, a system is disclosed for extracting attributes from textual content. The system includes a domain-adversarial model training engine and a textual attribute extractor. The domain-adversarial model training engine is provided for training a domain-invariant attribute extraction model for extracting predetermined attributes from textual content from multiple domains by learning domain-independent semantics of the attributes. The training data used for training includes a plurality of training samples, each with textual content, some of the predetermined attributes in the textual content, and a label indicating one of the multiple domains that produces the textual content. The textual attribute extractor is provided for extracting, from a new textual content from any of the multiple domains, some of the predetermined attributes based on the trained domain-invariant attribute extraction model according to the learned semantics of the predetermined attributes.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for attribute extraction from textual content. When the information is read by the machine, the machine performs the following steps. A domain-invariant attribute extraction model is trained for extracting predetermined attributes from textual content from multiple domains based on training data having a plurality of training samples, each with textual content, some of the predetermined attributes in the textual content, and a label indicating one of the multiple domains that produces the textual content. The domain-invariant attribute extraction model learns via training the semantics of the predetermined attributes across the multiple domains so that when a new textual content from any of the multiple domains, some predetermined attributes are extracted according to semantics thereof via the domain-invariant attribute extraction model.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an exemplary conventional system to extract attributes from textual content from different domains;

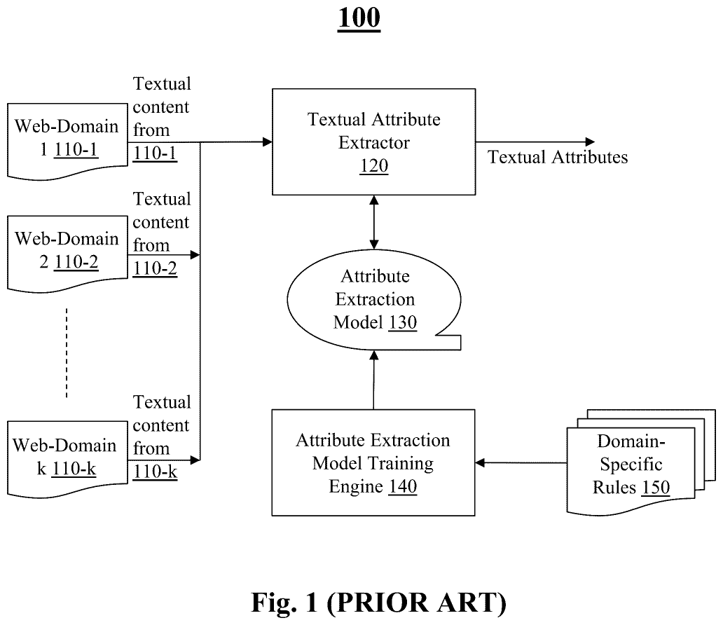

FIG. 2 shows content with different construct some of which are without rules on how attributes may be presented;

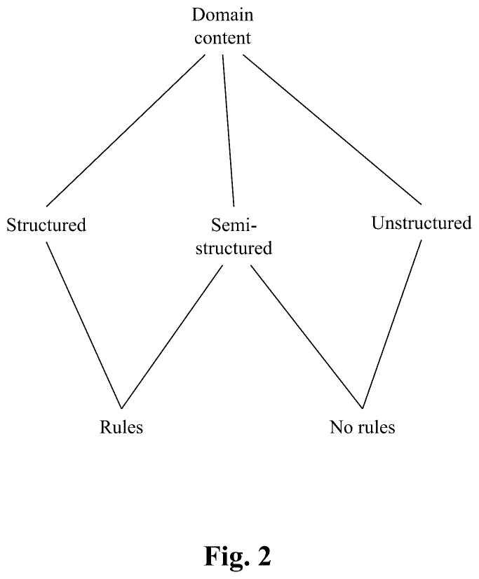

FIG. 3A depicts an exemplary high level system diagram of a framework for attribute extraction in a domain-invariant manner, in accordance with an embodiment of the present teaching;

FIG. 3B is a flowchart of an exemplary process of a framework 300 for attribute extraction in a domain-invariant manner, in accordance with an embodiment of the present teaching;

FIG. 4 depicts an exemplary high-level system diagram of a domain-invariant attribute extraction model, in accordance with an embodiment of the present teaching;

FIG. 5 shows an exemplary implementation of an attribute extraction model via an encoder-decoder architecture, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for extracting attributes appearing in textual content originated from different web domains in a manner that is independent of the source domain. That is, the present teaching discloses a domain-invariant approach to attribute extraction. That is, the present teaching stays away from the conventional approach that depends on rules to extract attributes from textual content where the rules are determined with respect to domains so that the conventional approach is domain dependent. According to the present teaching, a domain-invariant attribute extraction model is trained to learn the semantics of the attributes to be extracted via machine learning, instead of providing mechanical rules specifying the structural or other stylish information (such as distinct construct used and/or vocabulary used) associated with different domains. In training the domain-invariant attribute extraction model, domain adversarial training is employed, where two sub-models are trained simultaneously, one for learning knowledge about domains and the other for learning the semantics of the attributes to be extracted. As the semantics of attributes to be extracted are mingled or co-exist with information associated with domains, the semantics of the attributes are learned, according to the present teaching, with the influence (or independent) of the mingled information associated with domains excluded. With the knowledge about the true semantics of the attributes, the trained domain-invariant attribute extraction model can be deployed to take textual content from any of multiple domains and extract attributes without regard which domain the textual content is associated with. The present teaching is provided to steer the learning process towards learning the semantic related features of the attributes rather than domain-specific knowledge to facilitate extraction of attributes across diverse web-domains.

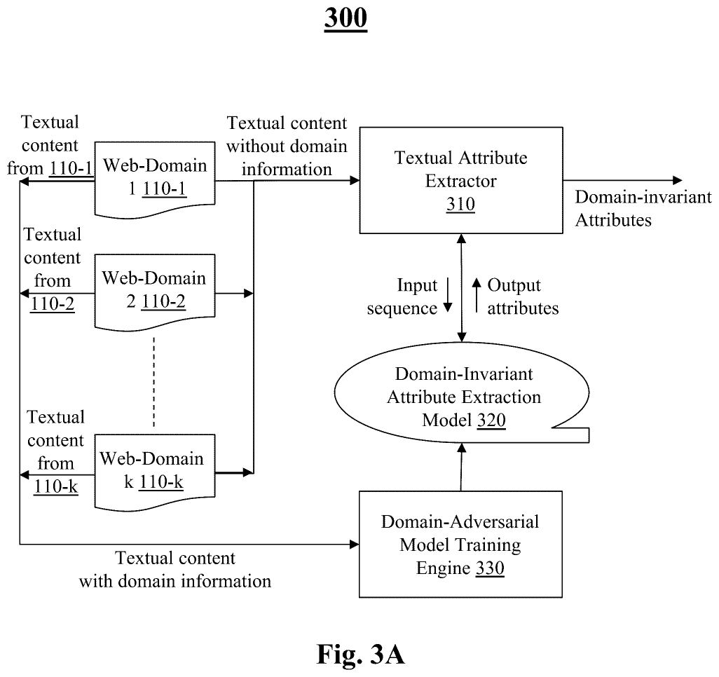

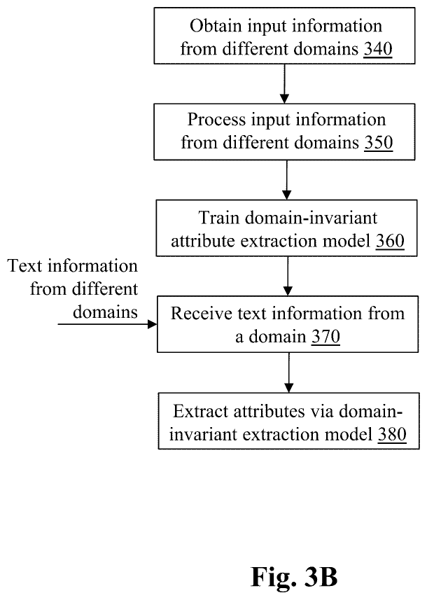

FIG. 3A depicts an exemplary high level system diagram of a framework 300 for extracting attributes in a domain-invariant manner, in accordance with an embodiment of the present teaching. In this framework 300, a plurality of web-domains 110, web-domain 1 110-1, web-domain 2 110-2, . . . , web-domain k 110-k, may originate different pieces of textual content and various attributes may be extracted from such textual content. For example, textual content may include emails from Amazon (a web-domain), eBay (another different web-domain), and Etsy (yet another different web-domain) or transaction records associated with a user account at a manufacturer website. Example attributes to be extracted from a piece of textual content from any of the web-domains may include, e.g., a user account, a transaction identifier, one or more products transacted under the transaction identifier, the cost of each product, the shipping cost, as well as the delivery schedule.

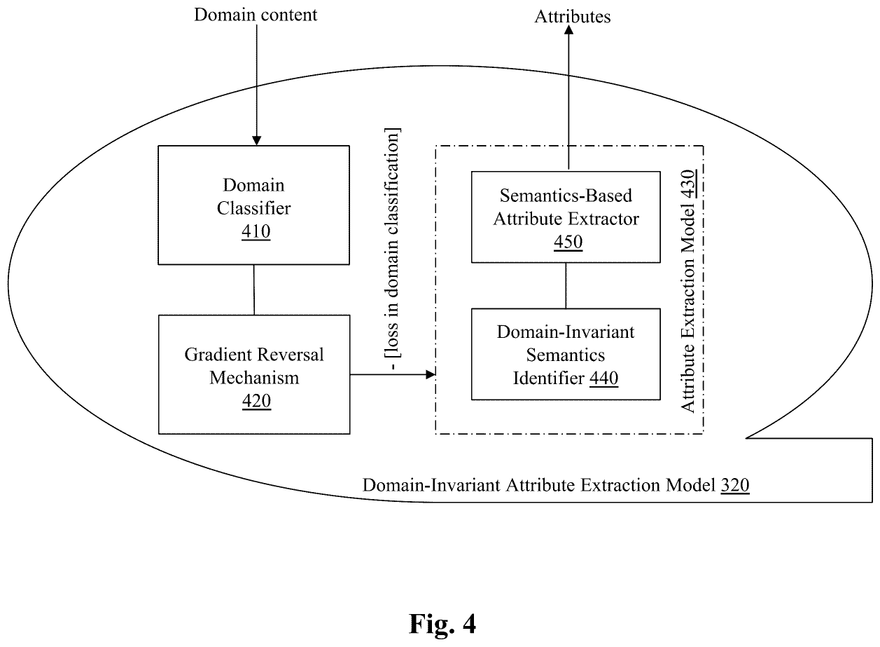

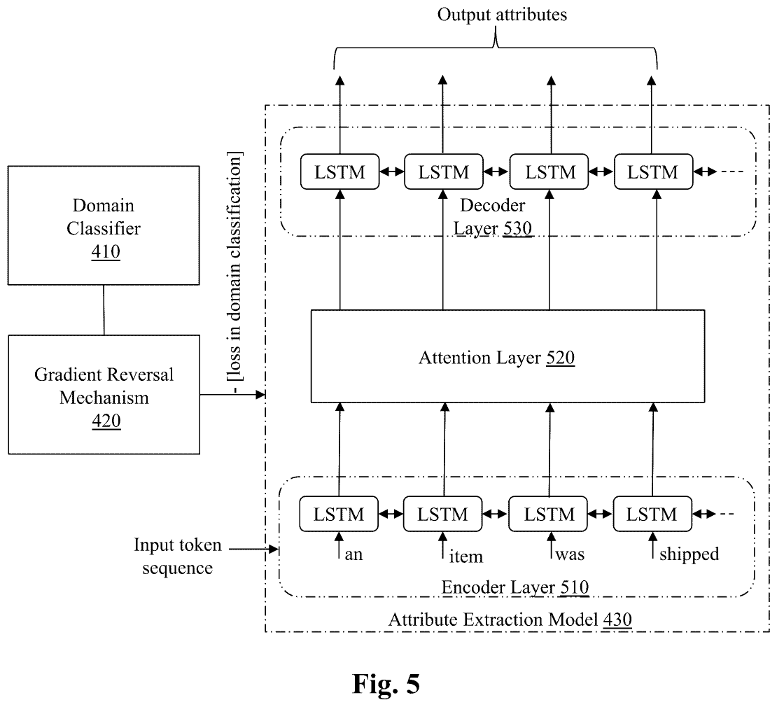

Such attributes may be presented in different ways (structures and formats) in textual content from different web-domains. The framework 300 includes a textual attribute extractor 310 provided for performing domain-invariant attribute extraction based on input textual content from any of the web-domains 110. As illustrated in FIG. 3A, the textual attribute extractor 310 may operate based on a domain-invariant attribute extraction model 320 obtained via learning the actual semantics of the attributes to be extracted by excluding the influence associated with the web-domain of the input textual content. The framework 300 also includes a domain-adversarial model training engine 330 provided for pieces of taking textual content from multiple web-domains 110-1, 110-2, . . . , 110-k with domain information as input, generating training data for training the domain-invariant attribute extraction model 320, in accordance with the present teaching so that the trained model 320 learns only the semantics of the attributes to be extracted without the impact of information associated with web-domain, despite the fact that knowledge related to the attributes and that of the web-domain co-exist in the textual content. Details on the domain-invariant attribute extraction model 320 and the training thereof are provided with reference to FIGS. 4-5.

The trained domain-invariant attribute extraction model 320, once trained, may be utilized by an application to extract attributes from the web-domains in a domain-invariant manner. In some embodiments, the trained domain-invariant attribute extraction model 320 may be used as a service so that it may take input textual content from different applications and return corresponding extracted attributes extracted therefrom as output. The textual attribute extractor 310 as illustrated in FIG. 3A may correspond to such an application. In some embodiment, the textual attribute extractor 310 and the domain-invariant attribute extraction model 320 may be combined.

FIG. 3B is a flowchart of an exemplary process of framework 300 for attribute extraction in a domain-invariant manner, in accordance with an embodiment of the present teaching. The flowchart includes both the operation of generating the domain-invariant attribute extraction model 320 as well as the operation of extracting attributes from a given piece of textual content from any of the web-domains using the domain-invariant extraction model 320. In operation, to obtain the domain-invariant attribute extraction model 320, the domain-adversarial model training engine 330 obtains, at 340, input data which includes both textual content from different domains as well as information indicative of the web-domain originated the textual content. Inclusion of the information about the web-domain may be for training the model 320 to exclude such information in extracting attributes. The input information (textual content and respective sources of web-domains) is then processed, at 350, to generate training data, which is then used to train, at 360, the domain-invariant attribute extraction model 320. The trained model 320 may then be used by the textual attribute extractor 310 (application of the model 320) receives, at 370, textual content from any of the web-domains, it may then utilize the domain-invariant attribute extraction model 320 to extract, at 380, attributes from the input textual content.

In some embodiments, the domain-invariant attribute extraction model 320 may be realized as a sequence-to-sequence model that takes a sequence of tokens from an input textual content as input and produce an output sequence of tokens representing attributes to be extracted from the input textual content. To derive such a model, domain content may be used as training data with textual content, attributes to extracted, and labeled source web-domains to enable learning of domain-invariant semantics of attributes and excluding domain-specific features. Such training data may be generated using the conventional rule-based approaches with respect to different web-domains to facilitate the learning so that the domain-invariant model 320 may not only learn the semantics of the attributes across different web-domains but also to generalize to unseen web-domains.

FIG. 4 depicts an exemplary high-level system diagram of the domain-invariant attribute extraction model 320, in accordance with an embodiment of the present teaching. In this illustrated embodiment, the domain-invariant attribute extraction model 320 comprises two parts, one corresponding to adversarial domain-based gradient reversal mechanism and the other corresponding to attribute extraction. The two parts may interact during training to achieve domain adversarial training with the goal of learning domain-invariant representations of attributes so that it is insensitive to the web-domains or unaffected by variations in input textual content caused by web-domains. As discussed herein, this is to enable the model 320 to recognize semantic features related to attributes (as opposed to relating to the web-domains) to improve its ability of generalization. As illustrated in FIG. 4, the first part includes a domain classifier 410 and a gradient reversal mechanism 420. The second part corresponds to an attribute extraction model 430 that includes a domain invariant semantics identifier 440 and a semantic-based attribute extractor 450.

During learning, domain content with text with domain labels indicating the source of the text may be used as training data to train the domain classifier 410 to recognize the domain associated with each input textual content. That is, the domain classifier 410 is trained to learn characteristics of web-domains and such learned domain-specific characteristics are to be ignored by the attribute extraction model 430 so that attributes may be extracted in a domain-invariant manner. To achieve that, the gradient reversal mechanism 420 is provided to interface with the attribute extraction model 430 to impact its training. In the illustrated embodiment, the domain classifier 410 is trained by minimizing a loss function using a gradient descent algorithm to learn the characteristics relevant to domains. The better the domain classifier 410 is trained, the better it is that the domain classifier 410 gains the domain-specific knowledge, which is to be excluded in the domain adversarial training of the attribute extraction model 430, according to the present teaching. To achieve that, the gradient reversal mechanism 420 may provide the reversed loss function values to the domain adversarial training process for the attribute extraction model 430 to desensitize the model 430 from the learned domain-specific characteristics. To effectuate the adversarial impact of the reversed loss function values from the gradient reversal mechanism 420, such reversed loss function values may be incorporated into the loss function used in training the attribute extraction model 430.

The exemplary embodiment of the attribute extraction model 430 may represent a general construct, where attribution extraction may be performed in a two-stage process. The first stage is to identify, by the domain invariant semantics identifier 440, domain-invariant semantics associated with attributes. The second state is to extract, by the semantic-based attribute extractor 450, attributes based on the domain-invariant semantics identified in the first stage. In some embodiments, this two-stage process may be implemented as a single model with two stages integrated. FIG. 5 shows an exemplary implementation of the attribute extraction model 430 via an encoder-decoder architecture, in accordance with an embodiment of the present teaching. In this illustrated encoder-decoder implementation for the attribute extraction model 430, it comprises an encoder layer 510, an attention layer 520, and a decoder layer 530. The encoder layer 510 is provided to take a sequence of tokens from an input textual content and the decoder layer 530 is provided to generate a set of attributes identified from the sequence of tokens. The attention layer 520 may be provided to detect the relationships among the sequence of tokens.

In some embodiments, the encoder layer 510 and decoder layers 530 may be implemented using long short-term memory (LSTM) units connected in series. The input tokens are provided to the serially connected LSTM units in an order as they appear in the sequence. One example is shown in FIG. 5, where input tokens “an,” “item,” “was,” “shipped,” etc. are input to the encoder layer 510 in the same order. The LSTM units in encoder 510 are parameterized so that parameters therein may be iteratively adjusted during learning based on some criteria, e.g., minimizing some loss function. The attention layer 520 may be provided to learn the relationships among different components (such as tokens) in a textual content and may be implemented using a, e.g., neural network. Parameters associated with the attention layer 520 may also be iteratively adjusted in an iterative learning process in minimizing the loss function. The decoder layer 530 may be similarly constructed using serially connected LSTM units as shown in FIG. 5 and parameters associated with the LSTM units in the decoder 530 may also be adjusted during learning in minimizing the loss function. The attribute extraction model 430 is trained by generating attributes based on each input sequence of tokens and the parameters in then encoder 510, attention layer 520, and the decoder layer may be adjusted in each iteration based on, e.g., the discrepancies between the attributes produced by the decoder 530 and the ground truth attributes and the adjustments to the parameters are determined by minimizing the loss function.

To consider the adversarial impact of the reversed loss function values from the gradient reversal mechanism 420, the reversed loss function values may be incorporated into the loss function used in training the attribute extraction model 430. Because the loss from training the domain classifier is negated as an input to learning the model parameters of the attribute extraction model 430, it removes the influence of domain information and forces the learning focusing on semantics of the textual information. For example, during training, the adversarial domain classifier 410, denoted as a, may be trained to predict the web-domain zᵢ with respect to a loss function. The encoder layer 510, denoted as e, may be trained by incorporating the reversed loss in domain classification from the gradient reversal mechanism 420 into the formulation of its loss function so that the domain-specific knowledge represented by the reversed loss in domain classification may be leveraged to negate the adversarial influence of the domain-specific knowledge.

The loss function Z used in training the encoder/decoder may be formulated as follows. First, the loss function L for training the domain classifier 410 (denoted by a) may be provided in equation (1), which defines the loss function in classifying a training sample xᵢ into a web-domain zᵢ.

$$arg {min}_{{θ}_{a}} L ( a ( h ( {x}_{i} ) ) , {𝓏}_{i} ) \qquad ( 1 )$$

The encoder 510 (or e) and the decoder 530 (or d) may be simultaneously trained based on a sequence of training samples xᵢ from the training data to produce a sequence of attributes, denoted by [symbol] ᵢ. The loss function for training the encoder/decoder may incorporate the loss associated with the domain classification as in equation (2), where the loss from domain classification is incorporated in the formulation in a reversed or negated form to achieve the intent to exclude the domain-specific knowledge and focus on learning the semantics of the attributes. That is, the loss used for training the encoder/decoder is the loss caused by discrepancies between a sequence of attributes.

$$arg {min}_{{θ}_{h} , {θ}_{d}} L ( d ( h ( {x}_{i} ) ) , {𝒴}_{i} ) - L ( a ( h ( {x}_{i} ) ) , {𝓏}_{i} ) \qquad ( 2 )$$

The objective function designed in these exemplary formulations to guide the training procedure to drive to achieve two key goals. The first goal may be to encourage the encoder-decoder to generate representations that are informative for the defined extraction task. The second goal is to compel such representations be minimally influenced by features related to web-domains by incorporating the reversed loss from domain classification. Through this framework, the domain-invariant attribute extraction model 320 learns of semantics of the attributes to be extracted with domain-specific information excluded therefrom. That is, the semantics learned are domain-invariant.

As discussed above, in some embodiments, the optimization of the domain classifier 410 is based on a gradient descent algorithm (GRL). With the gradient reversal mechanism 420 positioned over the encoder representation and before the adversarial classifier layer. During the forward pass, this may act as an identity layer. During backpropagation, it may multiply gradients by −λ to promote domain-invariant representations. The overall objective may then be:

$$arg {min}_{{θ}_{h} , {θ}_{d} , {θ}_{a}} L ( d ( h ( {x}_{i} ) ) , {𝒴}_{i} ) - L ( a ( {GRL}_{λ} ( h ( {x}_{i} ) ) ) , {𝓏}_{i} ) \qquad ( 3 )$$

Such a formulated objective function introduces a mechanism for enhancing domain-invariant representations, which facilitates the domain-invariant attribute extraction model 320 to generalize across different web-domains in extracting attributes from textual content therefrom.

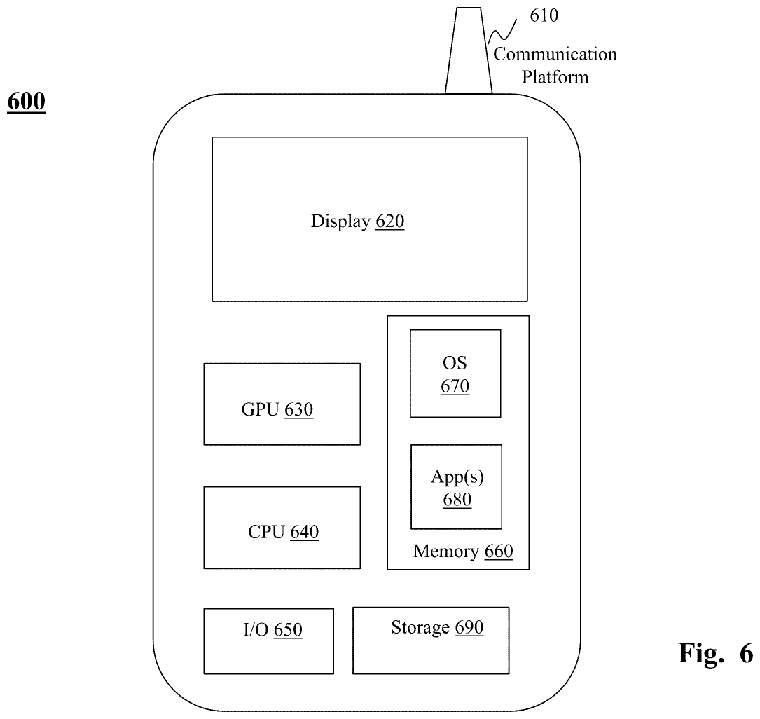

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 600. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

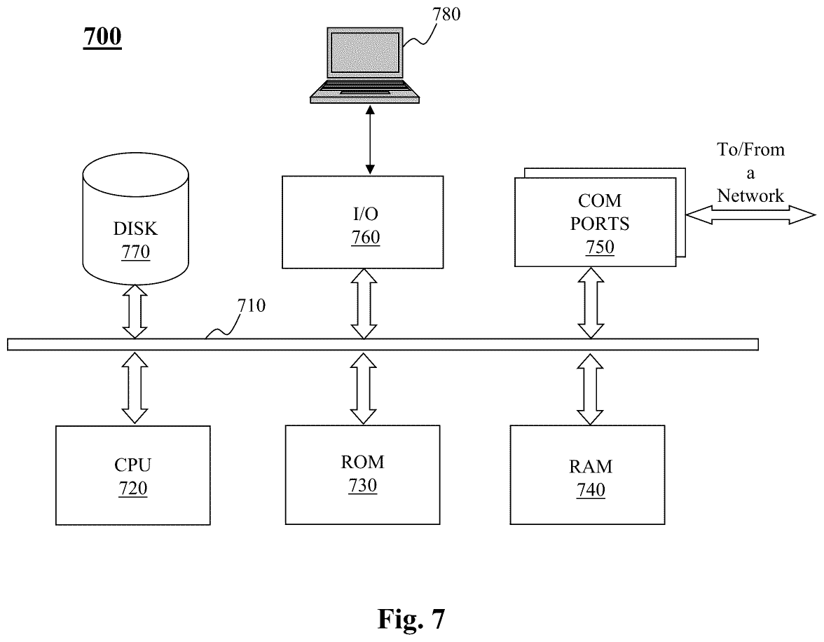

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
obtaining training data for training a domain-invariant attribute extraction model to be used to extract predetermined attributes from textual content from multiple domains, wherein the training data includes a plurality of training samples, each of which comprises textual content, one or more of the predetermined attributes extracted from the textual content, and a label corresponding to one of the multiple domains that produces the textual content;
training a domain-invariant attribute extraction model based on the training data, wherein the domain-invariant attribute extraction model models the semantics of the predetermined attributes across the multiple domains;
receiving textual content from any one of the multiple domains; and
extracting, based on the trained domain-invariant attribute extraction model, one or more of the predetermined attributes according to the semantics of the one or more of the predetermined attributes.

2. The method of claim 1, wherein
each of the multiple domains corresponds to a web platform through which a user conducts online activities;
the textual content from one of the multiple domains describes a transaction a user carries out via the domain; and
the predetermined attributes to be extracted from the textual content include features associated with different aspect of the transaction.

3. The method of claim 1, wherein the domain-invariant attribute extraction model is trained using domain adversarial learning.

4. The method of claim 3, wherein the domain-invariant attribute extraction model comprises a first part and a second part, wherein
the first part is for modeling domain-specific characteristics with respect to the multiple domains;
the second part is for modeling domain-invariant semantics of the predetermined attributes; and
the first part and the second part interact.

5. The method of claim 4, wherein
the first part influences the modeling of the second part by sending information representing domain-specific characteristics learned by the first part to the second part; and
the second part excludes, based on the information from the first part, influence of the domain-specific characteristics in learning domain-invariant semantics of the predetermined attributes by negating, impact of the domain-specific characteristics, in optimization in training the second part.

6. The method of claim 4, wherein the second part is constructed using an encoder-decoder architecture with an attention layer between an encoder layer and a decoder layer.

7. The method of claim 6, wherein
the encoder layer comprises a first multiple serially connected long short-term memory (LSTM) units, each of which corresponds to a token from the textual content; and
the decoder layer comprises a second multiple serially connected long short-term memory (LSTM) units, each of which corresponds to one of the predetermined attributes recognized from the textual content.

8. A machine readable and non-transitory medium having information recorded thereon, wherein the information, once read by the machine, causes the machine to perform the following steps:
obtaining training data for training a domain-invariant attribute extraction model to be used to extract predetermined attributes from textual content from multiple domains, wherein the training data includes a plurality of training samples, each of which comprises textual content, one or more of the predetermined attributes extracted from the textual content, and a label corresponding to one of the multiple domains that produces the textual content;
training a domain-invariant attribute extraction model based on the training data, wherein the domain-invariant attribute extraction model models the semantics of the predetermined attributes across the multiple domains;
receiving textual content from any one of the multiple domains; and
extracting, based on the trained domain-invariant attribute extraction model, one or more of the predetermined attributes according to the semantics of the one or more of the predetermined attributes.

9. The medium of claim 8, wherein
each of the multiple domains corresponds to a web platform through which a user conducts online activities;
the textual content from one of the multiple domains describes a transaction a user carries out via the domain; and
the predetermined attributes to be extracted from the textual content include features associated with different aspect of the transaction.

10. The medium of claim 8, wherein the domain-invariant attribute extraction model is trained using domain adversarial learning.

11. The medium of claim 10, wherein the domain-invariant attribute extraction model comprises a first part and a second part, wherein
the first part is for modeling domain-specific characteristics with respect to the multiple domains;
the second part is for modeling domain-invariant semantics of the predetermined attributes; and
the first part and the second part interact.

12. The medium of claim 11, wherein
the first part influences the modeling of the second part by sending information representing domain-specific characteristics learned by the first part to the second part; and
the second part excludes, based on the information from the first part, influence of the domain-specific characteristics in learning domain-invariant semantics of the predetermined attributes by negating, impact of the domain-specific characteristics, in optimization in training the second part.

13. The medium of claim 11, wherein the second part is constructed using an encoder-decoder architecture with an attention layer between an encoder layer and a decoder layer.

14. The medium of claim 13, wherein
the encoder layer comprises a first multiple serially connected long short-term memory (LSTM) units, each of which corresponds to a token from the textual content; and
the decoder layer comprises a second multiple serially connected long short-term memory (LSTM) units, each of which corresponds to one of the predetermined attributes recognized from the textual content.

15. A system, comprising:
a domain-adversarial model training engine implemented by a processor and configured for:
obtaining training data for training a domain-invariant attribute extraction model to be used to extract predetermined attributes from textual content from multiple domains, wherein the training data includes a plurality of training samples, each of which comprises textual content, one or more of the predetermined attributes extracted from the textual content, and a label corresponding to one of the multiple domains that produces the textual content, and
training a domain-invariant attribute extraction model based on the training data, wherein the domain-invariant attribute extraction model models the semantics of the predetermined attributes across the multiple domains; and
a textual attribute extractor implemented by a processor and configured for:
receiving textual content from any one of the multiple domains, and
extracting, based on the trained domain-invariant attribute extraction model, one or more of the predetermined attributes according to the semantics of the one or more of the predetermined attributes.

16. The system of claim 15, wherein
each of the multiple domains corresponds to a web platform through which a user conducts online activities;
the textual content from one of the multiple domains describes a transaction a user carries out via the domain; and
the predetermined attributes to be extracted from the textual content include features associated with different aspect of the transaction.

17. The system of claim 15, wherein
the domain-invariant attribute extraction model is trained using domain adversarial learning and comprises a first part and a second part, wherein
the first part is for modeling domain-specific characteristics with respect to the multiple domains;
the second part is for modeling domain-invariant semantics of the predetermined attributes; and
the first part and the second part interact.

18. The system of claim 17, wherein
the first part influences the modeling of the second part by sending information representing domain-specific characteristics learned by the first part to the second part; and
the second part excludes, based on the information from the first part, influence of the domain-specific characteristics in learning domain-invariant semantics of the predetermined attributes by negating, impact of the domain-specific characteristics, in optimization in training the second part.

19. The system of claim 17, wherein the second part is constructed using an encoder-decoder architecture with an attention layer between an encoder layer and a decoder layer.

20. The system of claim 19, wherein
the encoder layer comprises a first multiple serially connected long short-term memory (LSTM) units, each of which corresponds to a token from the textual content; and
the decoder layer comprises a second multiple serially connected long short-term memory (LSTM) units, each of which corresponds to one of the predetermined attributes recognized from the textual content.
